(19) United States
(12) Patent Application Publication
(10) Pub. No.: US 2016/0031165 A1
(43) Pub. Date: Feb. 4, 2016

(54) FIBER-LAYING DEVICE

(71) Applicant: Deutsches Zentrum für Luft- und Raumfahrt e.V., Koln (DE)

(72) Inventor: Duy Chinh NGUYEN, Stade (DE)

(21) Appl. No.: 14/810,625

(22) Filed: Jul. 28, 2015

(30) Foreign Application Priority Data
Jul. 31, 2014 (DE) 10 2014 110 909.0

(51) Int. Cl. B29C 70/38; B65H 59/10; B65H 57/00

(52) U.S. Cl. CPC B29C 70/384; B65H 57/00; B65H 59/10; B29K 2105/12

(57) ABSTRACT

A fiber-laying device is disclosed for laying continuous fiber material which is conveyed from a fiber storage unit to a fiber-laying head which is movable in space. The fiber materials here are guided along the kinematic chain of the robot, wherein an equalization system for equalizing length variations during movement of the robot is provided in the fiber-material storage unit.

### FIELD OF THE INVENTION

The invention relates to a fiber-laying device for laying continuous fiber material for manufacturing a fiber-composite component.

### BACKGROUND

Today's aerospace industry is inconceivable without components made from a fiber-composite material, which are also referred to as fiber-composite components. However, the use of materials of this type is also becoming increasingly widespread in the automotive sector. Critical structural elements in particular are made from fiber-reinforced plastics on account of their high weight-specific strength and rigidity combined with minimum weight. On account of the anisotropic properties of the fiber-composite materials resulting from the orientation of the fibers, components may be adapted to local stress and thus enable optimum exploitation of the material in the context of lightweight construction.

One disadvantage of fiber-composite materials lies in their production costs which in relation to other conventional materials are higher and which most often are a result of many manufacturing or production steps having to be carried out manually. In the case of large components made from fiber-composite materials, increasing automation of individual production steps such as, for example, automated laying of the fibers onto a tool by means of robots, can be thus observed. The fibers or semi-finished fiber products, respectively, here are laid onto the tool by a fiber-laying head which is disposed as an end effector on a robotic arm. As the fibers are laid onto the tool, the laying head here is displaced with the aid of the robot according to a predefined motion pattern, such that the fibers can be correspondingly laid onto the tool.

Fibers or fiber material, respectively, which are/is employed in particular include continuous fiber materials having a profile with a flat cross section, such as towpreg, slit tape, fiber strands, rovings, as well as cross-laid strands and fabrics strands. The fiber material here has to be conveyed or transported, respectively, from a stationary fiber hopper or a fiber-material storage unit, respectively, to the laying head (fiber-laying unit) which is freely movable in space. However, on account of the freedom of movement in space of the laying head, the spacing and the direction thereof between the stationary fiber-material storage unit and the laying head is continuously varied, such that unintended tensile forces act on the fiber material and excess fiber material may be created, respectively.

Apart from the gantry-type plants which have been traditionally used, multiaxial automatons, such as articulated robots or articulated-arm robots, respectively, which allow for higher flexibility in the production process, are increasingly being employed in the fiber-laying process. The individual members of an automaton of this type here are interconnected by way of linear guides and/or rotary joints so as to form a kinematic chain, wherein in particular in the case of industrial robots a distinction is made between one or a plurality of main axis/axes and the head axes (also referred to as sub-axes) which are provided in the proximity of the end effector. The main axes of an industrial robot here enable free positioning in space of an end effector, while the head axes are primarily responsible for orienting the tool and most often are composed of a series of rotary joints. Often, at least two of the three main axes are provided so as to be parallel in the kinematic chain and in this manner form a Watt's linkage, such that a linear movement may be generated by way of the rotation movement of the two parallel main axes.

On account of the diversity of motion by way of which the end effectors may be moved in almost all six degrees of freedom, issues arise in terms of the infeed of the continuous fiber materials from the stationary fiber-material storage unit to the freely movable laying head. In order for reliable infeeding of the fiber materials to the fiber-laying head for the process to be ensured, intense tensile stress on the fiber material and excess material in the infeed chain should be avoided here.

In this manner, a fiber-laying unit having a fiber storage means, a robot, and a laying head is disclosed in EP 2 117 818 B1, in which the fiber material is supplied to the laying head with the aid of a flexible pipeline system. The fiber materials which are present in the fiber hopper as continuous fiber material or quasi-continuous fiber material, respectively, are conveyed within the flexible pipeline system, wherein the interior of the pipeline system is impingeable with a gas. However, on account of the closed pipe system the disadvantage arises that the fibers or fiber materials, respectively, while being supplied may bear on the interior walls of the pipes and thus may cause friction which may lead to damage to the fibers. On account of the intense flexing and twisting of the pipe system, said damage has to be avoided in particular in the case of intense movements and large variations of the spacing between the fiber storage means and the laying head.

In subsequently published DE 10 2013 107 039.6 an installation which is configured in the form of a link chain for infeeding a quasi-continuous material from a material storage means to a processing place is mentioned, wherein the quasi-continuous material therein is guided over rollers which are located in the individual links of the link chain. However, there is here the disadvantage that the link chain has to be supported with the aid of a support system, so as to be able to equalize the variable spacings between the laying head and the fiber material. Moreover, intense deflective movements from the home position lead to intense twisting and tilting movements of the link chain, which may lead to friction stress for the fibers on the rollers. Here too, damage to the fibers which is disadvantageous to the reliability of the process of the automated laying process is to be avoided.

Furthermore, subsequently published DE 10 2013 108 570.9 discloses a multi-line fiber guide in which the fibers are guided along the kinematic chain with the aid of transfer points which are disposed on the robot, wherein the transfer points are located in the rotation axes of the respective axes of the multiaxial robot. On account thereof, all tensile forces and excess material during movement of the robot can be eliminated, such that individual fiber strands may be reliably guided to the laying head. However, it has proven disadvantageous here that in the case of an increasing number of continuous fiber materials (for example fiber strands) which are to be simultaneously conveyed, not every individual fiber strand can in fact be positioned so as to be in the rotation axis of the rotary joint, such that during parallel operation undesirable tensile stress or excess material may arise in the case of individual fiber strands.

### SUMMARY

It is thus an object of the present invention to provide an improved fiber-laying device in which a multiplicity of continuous fiber materials, for example fiber strands, can be simultaneously guided in parallel to a fiber-laying unit which is disposed on a robot, without damage to material on account of movement of the robot and the tensile forces resulting therefrom, and/or excess material arising.

Accordingly, a fiber-laying device for laying continuous fiber material for manufacturing a fiber-composite component which has a multiaxial automaton, for example an industrial articulated-arm robot, is disclosed. A fiber-laying unit (fiber-laying head) for laying the continuous fiber material is disposed at the end of the kinematic chain of the multiaxial automaton, wherein the kinematic chain of the automaton comprises a plurality of joints, in particular rotary joints, in order for the fiber-laying unit to be moved in space. Furthermore provided is a fiber-material storage unit for providing the continuous fiber material to be laid, wherein the fiber-material storage unit may be able to receive a multiplicity of continuous fiber materials for example, which are to be simultaneously guided in a parallel manner to the fiber-laying unit. This is performed with the aid of a fiber-guiding installation which is provided on the fiber-laying device and by way of which the continuous fiber material is to be guided from the fiber-material storage unit to the fiber-laying unit which is remote from the fiber-material storage unit and is freely movable in space.

According to the invention, it is now proposed that the fiber-guiding installation has at least one deflection unit which is disposed on the automaton so as to be fixedly spaced apart from a joint of the kinematic chain of the automaton, such that at least two fiber-guiding portions are formed between the fiber-material storage unit and the fiber-laying unit.

According to the invention the fiber-laying device furthermore has a fiber-material equalization installation which in the fiber-infeed direction is provided ahead of the kinematic chain of the automaton and which is configured for compensating for a length variation of at least one fiber-guiding portion, when the fiber-laying device is moved through the multiaxial automaton. The fiber-material equalization installation in particular is configured for compensating a length variation of at least one fiber-guiding portion which correlates to the fixed spacing of the at least one deflection unit from the respective joint, such that, in particular in the case of a small spacing from the joint and a thus resulting small length variation of the fiber-guiding portion, the fiber-material equalization installation also has to equalize only this small length variation. The fiber-material storage unit here is likewise disposed so as to be stationary ahead of the kinematic chain of the automaton in the fiber-infeed direction, in particular so as to be opposite the automaton.

The fiber-material equalization installation is thus configured such that it can equalize a maximum length variation of the corresponding fiber-guiding portions which correlates to the fixed spacing of the at least one deflection unit from the respective joint. The smaller the spacing to the corresponding joint of the kinematic chain of the automaton is here, the more compact the fiber-material equalization installation can be constructed, since corresponding length variations will likewise be smaller.

The inventors here have recognized that the deflection unit does not have to be disposed directly in the rotation axis of the joints if the continuous fiber material is guided along the kinematic chain of the automaton, but that it is sufficient for the deflection unit or the deflection units, respectively, to be disposed at a fixed spacing from a joint of the kinematic chain which is in each case assigned to the deflection units, since on account of the fixed spacing the maximum length variation which arises during movement of the automaton is correlated and is thus predeterminable, such that this known maximum length variation may be compensated for with the aid of a fiber-material equalization installation when the continuous fiber-material is conveyed or supplied, respectively. The system thus operates within pre-calculated system limits, which significantly increases the reliability of the process.

An automaton in the context of the present invention in particular is understood to be an articulated-arm robot, the individual members of which are interconnected via rotary joints to form a kinematic chain. On account thereof, the fiber-laying unit which is provided as an end effector is movable in space in at least two spatial directions, preferably in all three spatial directions.

A fixed spacing of the deflection units from a joint of the kinematic chain in particular is understood to be that the deflection unit is disposed on the automaton such that in the event of any movement of the automaton the deflection unit at all times has a fixed spacing from the in each case respectively referenced joint. On account thereof, it can be ensured that by way of the at all times identical spacing of the deflection unit from the respective joint the maximum length variation is known, wherein moreover a spacing which is as small as possible from the respective joint leads to a considerably smaller length variation during movement of the automaton. Preferably, the closest joint is referenced here. Particularly preferably, the joint which is immediately subsequent or immediately preceding in the kinematic chain is referenced.

The deflection units may have rotatably mounted deflection rollers, for example, by way of which the fiber material is to be guided along the kinematic chain of the automaton.

According to one advantageous embodiment, the fiber-material equalization installation is disposed in the fiber-material storage unit, such that the fiber-material storage unit and the fiber-material equalization installation form a constructive unit. Tensile forces and/or excess material which arise(s) here may be compensated for already in the fiber-material storage unit, wherein compensation is thus carried out prior to the commencement of the kinematic chain of the automaton.

To this end it is advantageous for the fiber-material equalization installation to have at least one tensioning device which is configured for tensioning the continuous fiber material in the event of a length reduction and/or length extension of a fiber-guiding portion. Such a tensioning device may be a dancer system, for example, in which the continuous fiber material is tensioned by a weight force which is disposed between two rollers.

According to one advantageous embodiment, it is furthermore provided that the fiber-guiding installation in at least one fiber-guiding portion has a fiber guide which has a fixed fiber-guiding length, in order for a length variation of the fiber-guiding portion to be compensated for by the fiber-guide per se. On account thereof, it is possible for length equalization to be caused in a part-region of the kinematic chain, such that only the length variations of those fiber-guiding portions that have no fixed fiber-guiding length have to be compensated for by the fiber-material equalization installation.

For example, such a fixed fiber-guiding length may be implemented by a fiber guide which has a flexible pipe in the interior passage of which the fibers are guided, wherein the flexible pipes are in each case fastened at their start and end points. A fiber guide of this type has a fixed fiber-guiding length which is independent of the movement of the automaton, such that the path of the continuous fiber material does not vary during conveyance along the fiber guide.

Another possibility of a fixed fiber-guiding length is a fiber guide in which a plurality of connecting elements which are interconnected in an articulated manner are provided, wherein guide elements for guiding the continuous fiber material along the connecting elements are in each case provided on the joints. A fiber guide of this type may be a bar kinematics having rollers mounted in roller bearings on the joints, over which the fibers of the continuous fiber material are guided. If a plurality of fiber strands are guided to the fiber-laying unit, each fiber strand has a separate guide element, such that the fiber strands may be conveyed separately from one another.

According to one advantageous embodiment, the kinematic chain of the automaton has a first main rotary joint, following in the kinematic chain a second and third main joint, and further following in the kinematic chain at least two head axes for moving the fiber-laying unit. The fiber-guiding installation moreover has a first deflection unit, a second deflection unit, and a third deflection unit. The first deflection unit is disposed on the automaton so as to be fixedly spaced apart from the rotation axis of the first main rotary joint, such that a first fiber-guiding portion is formed between the fiber-material storage unit and the first deflection unit. For example, this first deflection unit may have a plurality of deflection rollers which are in each case disposed at a fixed spacing from the rotation axis of the first main rotary joint, which fixed spacing may be different from one deflection roller to another.

The second deflection unit is disposed on the automaton so as to be fixedly spaced apart from the rotation axis of the second main joint, such that a second fiber-guiding portion is formed between the first deflection unit and the second deflection unit. Here too, the second deflection unit may have a plurality of deflection rollers by way of which a plurality of continuous fiber materials may be guided in parallel, wherein each fiber-guiding roller is disposed so as to be fixedly spaced apart from the rotation axis of the second main joint.

Finally, the third deflection unit is disposed on the automaton so as to be fixedly spaced apart from the rotation axis of the third main joint, such that a third fiber-guiding portion is formed between the second deflection unit and the third deflection unit, and a fourth fiber-guiding portion is formed between the third deflection unit and the fiber-laying unit.

In this embodiment the fiber material is guided along the kinematic chain of the automaton, wherein guiding of the continuous fiber material is performed at a certain spacing from the respectively referenced joints, on account of which a predefined maximum length variation during movement of the automaton results. Said length variation is then compensated for by the fiber-material equalization installation which is disposed ahead of the kinematic chain of the automaton.

The fiber-guiding installation is advantageously configured such that the fourth fiber-guiding portion is equipped for bridging the head axes of the automaton, in particular for compensating for the movements in all three spatial directions. This may be implemented with the aid of flexible pipes or similar, as has already been described above.

It is thus particularly advantageous for the fiber-guiding installation in the fourth fiber-guiding portion to have a fiber guide for compensating for length variation between the third deflection unit and the fiber-laying unit, which has one or a plurality of flexible pipes in the internal passage of which the continuous fiber material is guided to the fiber-laying unit. Not only length variations of the fourth fiber-guiding portions may thus be compensated for with the aid of flexible pipes, but any movements between the third deflection unit and the fiber-laying head may be also be equalized at the same time in all three spatial directions.

According to one further advantageous embodiment, the first deflection unit has one or a plurality of deflection elements which is/are configured for guiding the continuous fiber material in a radial manner in relation to the rotation axis of the first main rotary joint of the kinematic chain. On account thereof, the continuous fiber materials are guided in parallel on the first deflection element, such that twisting movements of the fiber material during infeeding are eliminated.

Accordingly, it is likewise advantageous for the second and third deflection unit to have in each case one or more deflection elements which are configured for guiding the continuous fiber material in a radial manner to the rotation axes of the second and third main joint of the kinematic chain. According to one further advantageous embodiment, the fiber-material equalization installation is configured such that the length variation of the first, second, and third fiber-guiding portion which correlates to the fixed spacings of the first, second, and third deflection unit from their respective joints can be compensated for when the fiber-laying unit is moved through the multiple axes in the automaton. Advantageously, the fourth fiber-guiding portion here having a fiber guide is configured such that length variations are directly compensated for by the fiber guide.

### BRIEF DESCRIPTION OF THE DRAWINGS

The invention will be explained in an exemplary manner by means of the appended figures:

In the figures:

FIG. 1—shows a schematic illustration of an industrial robot having six axes of movement;

FIG. 2—shows a schematic illustration of the fiber-guiding system according to the invention.

### DETAILED DESCRIPTION

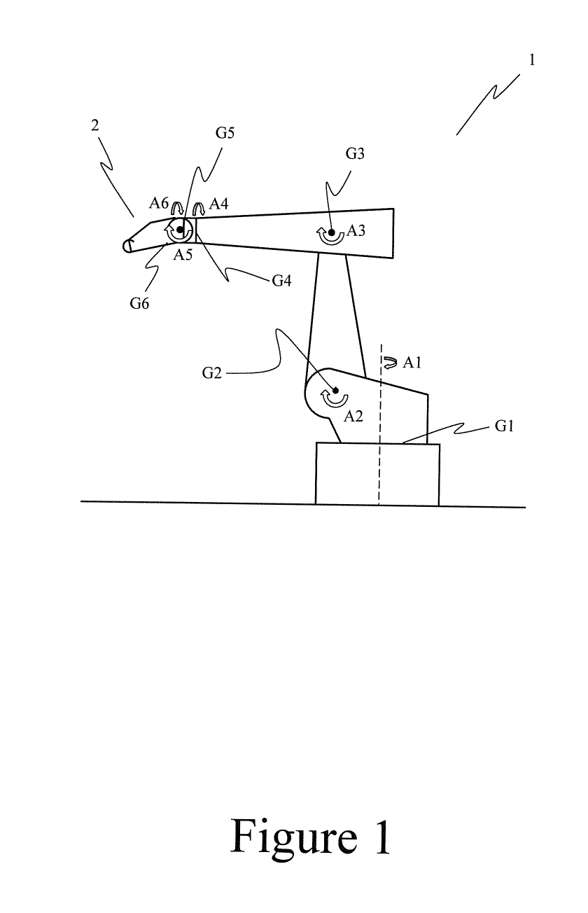

FIG. 1 shows in a schematic manner a six-axis articulated-arm robot which is often encountered in an industrial environment and which includes six rotation axes and thus can reach any arbitrary point in space. A six-axis articulated-arm robot of this type in practice is often used as a laying robot for laying fiber material, since the former has great flexibility.

The articulated-arm robot 1 has three main axes A1, A2, and A3, by way of which the fiber-laying head 2 or the fiber-laying unit, respectively, can be freely positioned in space. The three main axes A1, A2, and A3 here communicate with the joints G1, G2, and G3 which are in each case provided on the articulated-arm robot 1 and about which the respective link of the kinematic chain can be rotated.

The entire articulated-arm robot can be rotated about the main rotation axis A1 with the aid of the presently vertical main rotation axis A1. With the aid of the main axes A2 and A3 which are arranged so as to follow in the kinematic chain and which are present as horizontal rotation axes (and thus are parallel with one another), translatory movements of the end effector 2 can be performed. On account of the joints G2 and G3 having their main axes A2 and A3 a Watt's linkage is formed here, such that the fiber-laying unit by way of rotation movements about the rotation axes A2 and A3 can perform a linear or translatory movement, respectively.

The head axes A4, A5, and A6, having their respective joints G4, G5, and G6, serve mainly for orientating the fiber-laying head 2 and are likewise composed of rotary joints. The axes A4, A5, and A6, here are perpendicular in relation to one another.

If continuous fiber material is to be guided from a stationary fiber-material storage unit to the end effector 2, on account of the movement of the robot 1, length equalization between the stationary fiber-material storage unit and the fiber-laying head 2 has thus to be performed.

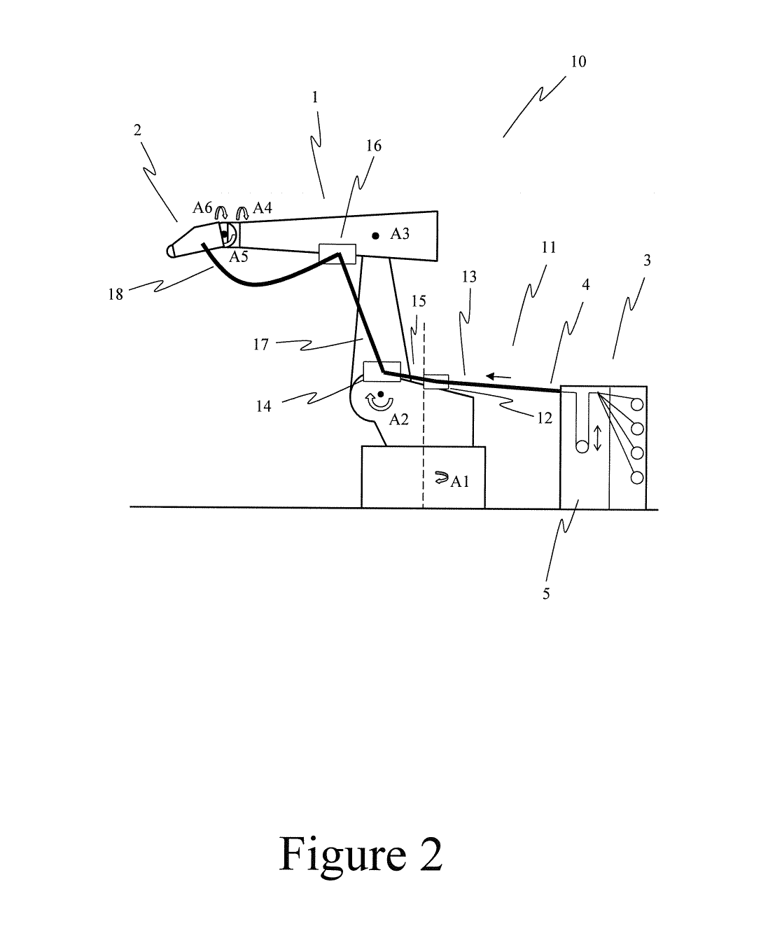

FIG. 2 shows in a schematic manner the fiber-laying device 10 according to the invention. The fiber-laying device 10 has an articulated-arm robot 1, such as described in FIG. 1, for example. A fiber-laying head 2 is disposed on the articulated-arm robot 1 as an end effector. The fiber-laying device 10 furthermore has a fiber-material storage unit 3 in which the continuous fiber material 4 is held and stored. The continuous fiber material 4 is then conveyed from the fiber-material storage unit 3 up to the fiber-laying head 2 which is disposed on the robot 1, such that the fiber-laying head 2 can lay the fiber material 4 onto a molding tool (not illustrated), for example.

The fiber-material storage unit 3 may provide the fiber material 4 on packages or rolls for example and in the interior may optionally be temperature controlled, so as to be able to adjust the required processing parameters in an optimal manner. Furthermore, the fiber-material storage unit 3 may have a multiplicity of continuous fiber materials 4, for example in the form of fiber strands or tapes which are wound on rolls and which are subsequently individually but in parallel guided to the fiber-laying head 2. The fiber-laying head 2 can then simultaneously lay the individual continuous fiber materials, for example in the form of fiber tapes, onto the molding tool. In this way, up to 16 continuous fiber materials, such as fiber tapes, for example, may be conveyed at the same time and in parallel to the fiber-laying head.

The fiber-laying device 10 furthermore has a fiber-guiding installation 11 by way of which the fibers or the fiber material 4, respectively, are to be conveyed from the fiber-material storage unit 3 along the kinematic chain of the robot 1 to the fiber-laying head 2, or are to be infed to the latter, respectively.

To this end, in the exemplary embodiment of FIG. 2 the fiber-guiding installation 11 has a first deflection unit 12 which is fixedly spaced apart from the main rotation axis A1 of the main rotary joint G1. On account thereof, the continuous fiber material 4 is initially inducted into the movement of the kinematic chain of the robot 1. A first fiber-guiding portion 13 is thus formed between the first deflection unit 12 and the fiber-material storage unit 3, which first fiber-guiding portion on account of the existing spacing of the deflection unit 12 from the main rotation axis A1 may change its length during movement of the robot 1.

For example, the first deflection unit 12 may have a plurality of deflection elements such as deflection rollers, for example, which may all have different spacings from the main rotation axis A1. In this way, it is conceivable, for example, for at least one deflection roller or one deflection element, respectively, to be disposed directly in the main rotation axis A1, while the remaining elements are provided with a respective spacing from the main rotation axis A1. On account thereof, a corresponding spacing of the first deflection unit 12 from the main rotation axis A1 results in total.

The fiber-guiding installation 11 furthermore has a second deflection unit 14 on the robot 1, which is disposed so as to be fixedly spaced apart from the second rotation axis A2. The fiber material 4 is now guided onward from the first deflection unit to the second deflection unit, wherein a second fiber-guiding portion 15 is formed between the first deflection unit and the second deflection unit.

Following in the kinematic chain, a third deflection unit 16 is disposed behind the third rotation axis A3, such that the fibers which are conveyed from the second deflection unit 14 to the third deflection unit 16 are guided in a third fiber-guiding portion 17 which is formed therebetween. The third deflection unit 16 here is disposed so as to be fixedly spaced apart from the rotation axis A3.

All three fiber-guiding portions 13, 15, and 17 may be configured such, for example, that the fiber material is guided in an open manner along the kinematic chain of the robot. Moreover, on account of the spacings to the respectively referenced joints or rotation axes, respectively, each fiber-guiding portion during corresponding movements of the robot 1 will vary in its length to a greater or lesser extent, such that on account thereof (loose) excess material, or in the case of a shortage of material, tensile forces may be created in the continuous fiber material 4, respectively.

To this end, a fiber-material equalization installation 5 is provided in the fiber-material storage unit 3 in the exemplary embodiment of FIG. 2, which is configured for compensating for length variation of one of the fiber-guiding portions. Compensation of this type may be performed, for example, with the aid of a dancer system, in which the fiber material is guided in a loop-type manner through a tensioning roller which equalizes the length variation which arises in one or a plurality of fiber-guiding portions by a corresponding length variation of the loop path in the vertical.

The fiber-material equalization installation 5 here is disposed ahead of the kinematic chain of the robot 1 in the fiber-infeed direction, such that a corresponding length-variation may be compensated for on each of the fiber-guiding portions.

Proceeding from the third deflection unit 16, a fourth fiber-guiding portion 18, of which the extremity is the fiber-laying head 2, is formed furthermore in the exemplary embodiment of FIG. 2. Since proceeding from the third deflection unit 16 to the fiber-laying head 3, head axes A4, A5, and A6 are bridged, it is particularly advantageous for the fourth fiber-guiding portion to have a fiber guide which directly compensates for length variation of the fourth fiber-guiding portion 18. This may be implemented, for example, by way of flexible pipes which are fixedly secured to the third deflection unit 16 and the fiber-laying head 2 and thus have a constant length across the conveying path. Length variation of the fourth fiber-guiding portion 18 here is compensated for by the deformation or the variation of the shape of the fiber guide at constant conveying distance, respectively.

### LIST OF REFERENCE SIGNS

1 Robot (automaton)
2 Fiber-laying head
3 Fiber-material storage unit
4 Continuous fiber material
5 Fiber-material equalization installation
10 Fiber-laying device
11 Fiber-guiding installation
12 First deflection unit
13 First fiber-guiding portion
14 Second deflection unit
15 Second fiber-guiding portion
16 Third deflection unit
17 Third fiber-guiding portion
18 Fourth fiber-guiding portion

I claim:

1. A fiber-laying device for laying continuous fiber material for manufacturing a fiber-composite component using a multiaxial automaton which at the end of its kinematic chain has a fiber-laying unit for laying the continuous fiber material, wherein the kinematic chain of the automaton comprises a plurality of joints in order for the fiber-laying unit to be moved in space, the fiber-laying device comprising:
a fiber-material storage unit for providing the continuous fiber material to be laid;
a fiber-guiding installation for infeeding the continuous fiber material from the fiber-material storage unit to the fiber-laying unit which is remote from the fiber-material storage unit and is movable in space, wherein the fiber-guiding installation comprises at least one deflection unit which is disposed on the automaton so as to be fixedly spaced apart from a joint of the kinematic chain of the automaton, wherein at least two fiber-guiding portions are formed between the fiber-material storage unit and the fiber-laying unit; and
a fiber-material equalization installation which is provided ahead of the kinematic chain of the automaton in the fiber-infeed direction and which is configured for compensating for a length variation of at least one fiber-guiding portion of the at least two fiber-guiding portions when the fiber-laying unit is moved by the automaton, the length variation correlating to the fixed spacing of the at least one deflection unit from the respective joint.

2. The fiber-laying device according to claim 1, wherein the fiber-material equalization installation is disposed in the fiber-material storage unit.

3. The fiber-laying device according to claim 1, wherein the fiber-material equalization installation has at least one tensioning device which is configured for tensioning the continuous fiber material in the event of one or more of a length reduction and length extension of a fiber-guiding portion.

4. The fiber-laying device according to claim 1, wherein the fiber-guiding installation in at least one fiber-guiding portion has a fiber guide which has a fixed fiber-guiding length, in order for a length variation of the fiber-guiding portion to be compensated for by the fiber-guide per se.

5. The fiber-laying device according to claim 1, wherein the kinematic chain of the automaton comprises, in the following order in the kinematic chain, a first main rotary joint, a second and third main joint, and at least two head axes for moving the fiber-laying unit, wherein the fiber-guiding installation includes
a) a first deflection unit which is disposed on the automaton so as to be fixedly spaced apart from a rotation axis of the first main rotary joint, the first deflection unit being disposed such that a first fiber-guiding portion is formed between the fiber-material storage unit and the first deflection unit,
b) a second deflection unit which is disposed on the automaton so as to be fixedly spaced apart from a rotation axis of the second main joint, the second deflection unit being disposed such that a second fiber-guiding portion is formed between the first deflection unit and the second deflection unit, and
c) a third deflection unit which is disposed on the automaton so as to be fixedly spaced apart from a rotation axis of the third main joint, the third deflection unit being disposed such that a third fiber-guiding portion is formed between the second deflection unit and the third deflection unit and a fourth fiber-guiding portion is formed between the third deflection unit and the fiber-laying unit.

6. The fiber-laying device according to claim 5, wherein the fourth fiber-guiding portion is configured for bridging the at least two head axes of the automaton.

7. The fiber-laying device according to claim 5, wherein the fiber-guiding installation in the fourth fiber-guiding portion has a fiber guide for compensating for length variation between the third deflection unit and the fiber-laying unit, the wherein the fiber guide has one or a plurality of flexible pipes in the internal passage of which the continuous fiber material is guided to the fiber-laying unit.

8. The fiber-laying device according to claim 5, wherein the first deflection unit has one or a plurality of deflection elements configured for guiding the continuous fiber material in a radial manner to the rotation axis of the first main rotary joint of the kinematic chain.

9. The fiber-laying device according to claim 5, wherein the second deflection unit has one or more deflection elements configured for guiding the continuous fiber material in a radial manner to the rotation axis of the second main joint of the kinematic chain, and wherein the third deflection unit has one or more deflection elements configured for guiding the continuous fiber material in a radial manner to the rotation axis of the third main joint of the kinematic chain.

10. The fiber-laying device according to claim 5, wherein the fiber-material equalization installation is configured for compensating the length variations of the first, second, and third fiber-guiding portions when the fiber-laying unit is moved by the automaton, wherein the length variations respectively correlate to the fixed spacings of the first, second, or third deflection units from the respective joints.
